(19) United States
(12) Patent Application Publication
(10) Pub. No.: US 2021/0392409 A1
(43) Pub. Date: Dec. 16, 2021

(54) MULTIMEDIA CHANNEL SWITCHING REMINDING SYSTEM AND METHOD

(71) Applicant: REALTEK SEMICONDUCTOR CORP., HSINCHU (TW)

(72) Inventor: LIEN-HSIANG SUNG, HSINCHU (TW)

(21) Appl. No.: 17/134,752

(22) Filed: Dec. 28, 2020

(30) Foreign Application Priority Data
Jun. 15, 2020 (TW) 109120030

(51) Int. Cl. H04N 21/482; H04N 21/472; H04N 21/488

(52) U.S. Cl. CPC H04N 21/482; H04N 21/488; H04N 21/47214

(57) ABSTRACT

A multimedia channel switching reminding system and a method are provided. The system includes a multimedia device and an audio and video processing device, which receives a multimedia audio and video source including a plurality of channel signals, plays one of a plurality of channels through the multimedia device, and includes a channel switching detection unit, a feature extraction module, a buffer storage unit, a comparing module and a reminder module. The channel switching detection unit detects whether or not a first channel is switched to a second channel among the plurality of channels. The feature extraction module extracts at least one program feature of a content of the channel signal corresponding to the first channel before the first channel is switched to the second channel The comparing module compares the channel signal of the first channel according to the program feature to generate a detection result.

### CROSS-REFERENCE TO RELATED PATENT APPLICATION

This application claims the benefit of priority to Taiwan Patent Application No. 109120030, filed on Jun. 15, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to multimedia channel switching reminding system and method, and more particularly to multimedia channel switching reminding system and method that can automatically notify channel switching for users.

### BACKGROUND OF THE DISCLOSURE

As technology progresses, the number of functions supported by multimedia devices also grows increasingly. A television (TV), for instance, not only provides a great number of channels and programs to select from, but can also be connected to other electronic devices such as digital versatile disc (DVD) players, personal computers, notebook computers or video game consoles, etc. Thus, a user can choose to watch different channels or switch the TV directly to a mode for receiving signals from external electronic apparatuses (e.g., signals from a composite video connector) and display pictures converted from the received signals on a screen according to different user requirements. Currently, most TV remote controls have recall buttons disposed close to the number buttons for allowing the user to quickly switch between two channels without having to re-input the channel numbers.

When watching TV, it is common for the user to switch the channel to another channel during commercial breaks. Since the action of switching channels is performed by the user, the user may miss parts of the originally watched program if they forget to switch back to the original channel in time.

Therefore, detecting the timing of switching channels and automatically notifying the user has become an important topic in the art.

### SUMMARY OF THE DISCLOSURE

In response to the above-referenced technical inadequacies, the present disclosure provides a multimedia channel switching reminding system and a method that can automatically notify channel switching for users.

In one aspect, the present disclosure provides a multimedia channel switching reminder system including a multimedia device and an audio and video processing device. The audio and video processing device is coupled to the multimedia device, receives a multimedia audio and video source including a plurality of channel signals, and is configured to play one of a plurality of channels through the multimedia device, the audio and video processing device includes a channel switching detection unit, a feature extraction module, a buffer storage unit, a comparing module and a reminder module. The channel switching detection unit is configured to detect whether or not a first channel is switched to a second channel among the plurality of channels. The feature extraction module is configured to, in response to the channel switching detection unit detecting that the first channel is switched to the second channel, extract at least one program feature of a content of the channel signal corresponding to the first channel before the first channel is switched to the second channel The buffer storage unit is configured to temporarily store the at least one program feature. The comparing module is configured to compare the channel signal of the first channel according to the at least one program feature to generate a detection result. The reminder module is configured to determine whether or not to remind a channel switching according to the detection result.

In another aspect, the present disclosure provides a multimedia channel switching reminding method, which includes the following steps: configuring an audio and video processing device to receive a multimedia audio and video source including a plurality of channel signals, and play one of a plurality of channels through the multimedia device; configuring a channel switching detection unit to detect whether or not a first channel is switched to a second channel among the plurality of channels; configuring a feature extraction module to, in response to the channel switching detection unit detecting that the first channel is switched to the second channel, extract at least one program feature of a content of the channel signal corresponding to the first channel before the first channel is switched to the second channel; configuring a buffer storage unit to temporarily store the at least one program feature; configuring a comparing module to compare the channel signal of the first channel according to the at least one program feature to generate a detection result; and configuring a reminder module to determine whether or not to remind a channel switching according to the detection result.

Therefore, the multimedia channel switching reminding system and method provided by the present disclosure can be applied to a television. When a user switches channels while a program on a certain channel or an input media viewed by the user plays advertisements, the system and method provided by the present disclosure can continuously monitor the content of the original channel or the input media in background, and remind the user when the advertising time of the original channel or the input media ends, such that the user does not miss out on his preferred programs.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a block diagram of a multimedia channel switching reminding system according to an embodiment of the present disclosure.

FIG. 2 is a schematic diagram showing the feature extraction module extracting channel content according to an embodiment of the present disclosure.

FIG. 3 is another schematic diagram showing the feature extraction module extracting the channel content according to an embodiment of the present disclosure.

FIG. 4 is a flowchart of a multimedia channel switching reminding method according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

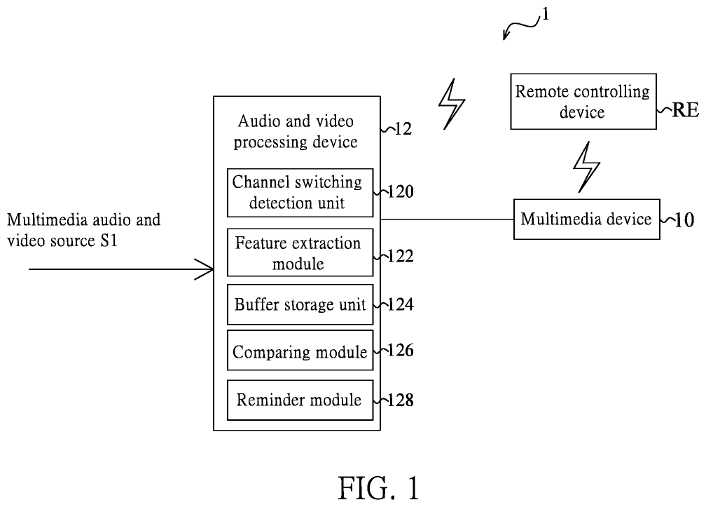

FIG. 1 is a block diagram of a multimedia channel switching reminding system according to an embodiment of the present disclosure. Reference is made to FIG. 1, and an embodiment of the present disclosure provides a multimedia channel switching reminding system 1, which includes a multimedia device 10 and an audio and video processing device 12.

The audio and video processing device 12 is coupled to the multimedia device 10, receives a multimedia audio and video source Si including a plurality of channel signals, and is configured to play one of a plurality of channels through the multimedia device 10. The audio and video processing device 12 includes a channel switching detection unit 120, a feature extraction module 122, a buffer storage unit 124, a comparing module 126 and a reminder module 128.

It should be understood that the audio and video processing device 12 can perform functions of the channel switching detection unit 120, the feature extraction module 122, the comparing module 126, and the reminder module 128 through a built-in processing unit, and the processing unit can utilize, for example, a hardware device composed of logic circuit elements to perform the above functions. In addition, the above-mentioned functions can also be performed by loading a program stored in a storage unit of the audio and video processing device 12, and the present disclosure is not limited thereto. In this embodiment, the processing unit can be a central processing unit, a field-programmable gate array (FPGA), or a multi-purpose chip that can load a programming language to perform corresponding functions.

The multimedia device 10 can be, for example, an analog TV, a digital photo frame display device, a desktop computer, a notebook computer, a tablet computer, a mobile phone, a smartphone, an e-book, or a multimedia display device.

The audio and video processing device 12 can receive the multimedia audio and video source S1 through a twisted pair, a coaxial cable, an optical fiber or other transmission media. In addition, the audio and video processing device 12 can also be an audio and video processing device that conforms to a specific interface, such as parallel advanced technology attachment (PATA) standard, Institute of Electrical and Electronic Engineers (IEEE) 1394 standard, high speed Peripheral Component Interconnect Express (PCI Express) standard, Universal Serial Bus (USB) standard, Ultra High Speed-I (UHS-I) interface standard, ultra-high-speed second-generation (Ultra High Speed-II, UHS -II) interface standard, Serial Advanced Technology Attachment (SATA) standard, Memory Stick (MS) interface standard, multimedia card (MMC) interface standard, Compact Flash (CF) interface standard, Integrated Device Electronics (IDE) standard or other suitable standards.

In addition, the audio and video processing device 12 can also receive the multimedia audio and video source 51 through a communication unit. The communication unit can be, for example, a wireless transceiver unit supporting wireless communication standards such as the Institute of Electrical and Electronics Engineers (IEEE) 802.11n/b/g and the like, which can establish a network connection with other external devices through wireless manners. In addition, the communication unit can also include protocols such as third generation telecommunication (3G) module, long term evolution (LTE) network communication interface, Wi-Fi module, or Bluetooth®, and the like, thereby establishing a network connection with other external devices through wireless manners. For example, the communication unit can have a wireless transceiver unit such as an antenna. In addition, the communication unit can also support a wired network, such as a network card, and the present disclosure is not limited thereto.

For example, the user can perform channel switching on the multimedia device 10 through a channel switching button of a remote controlling device RE. For example, when the user operates through the channel switching button of the remote controlling device RE, the channel switching detection unit 120 can be configured to detect whether or not a first channel is switched to a second channel among the plurality of channels. The user can set a currently viewed channel as the first channel through the remote controlling device RE, or the channel switching detection unit 120 can automatically set the channel currently played by the multimedia device 10 as the first channel.

When the first channel watched by the user enters advertisements from a specific program, the user can switch the channel of the multimedia device 10 through the channel switching button of the remote controlling device RE. At this time, the channel switching detection unit 120 detects that the first channel is switched to the second channel. The second channel can be any channel other than the first channel among the plurality of channels. In response to the channel switching detection unit 120 detecting that the first channel is switched to the second channel, the feature extraction module 122 can be configured to extract at least one program feature of a content of the channel signal corresponding to the first channel before switching from the first channel to the second channel.

For example, the at least one program feature can include at least one of program frame features, program mark features, program pattern features, program facial features, and program sound features in the content of the channel signal corresponding to the first channel before the first channel is switched to the second channel.

In detail, the program pattern features can include a program pattern corresponding to a program type. For example, when the first channel is a sports program, scores and names of competition teams may be usually displayed. When the first channel is a financial program, multiple investment product indexes may be displayed. The feature extraction module 122 can analyze frames and sounds of the first channel before switching to the second channel to obtain program features with repetitiveness or specific continuity, and store these features in the buffer storage unit 124.

The buffer storage unit 124 may be, for example, static random access memory (SRAM), dynamic random access memory (DRAM), hard disk, flash memory, or any memory or storage device that can be used to store electronic signals or data.

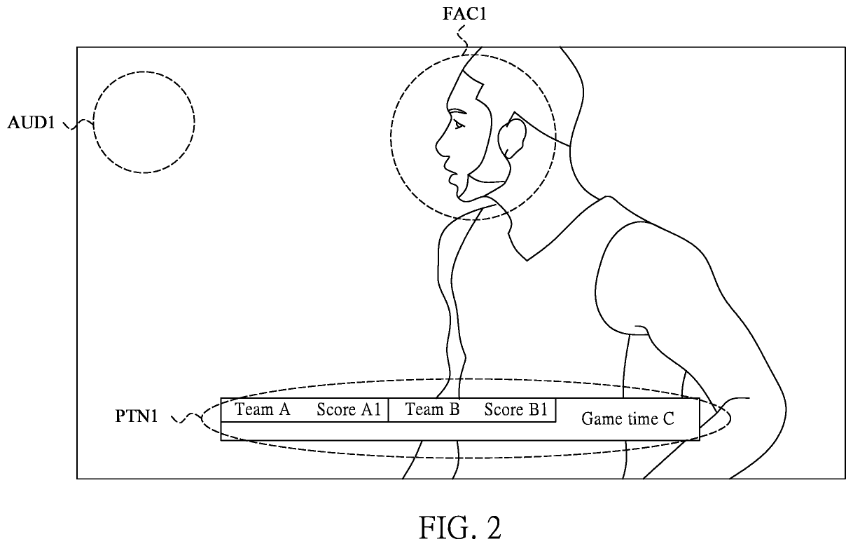

For example, reference can be made to FIG. 2, which is a schematic diagram showing the feature extraction module extracting channel content according to an embodiment of the present disclosure. For example, FIG. 2 shows a player playing a game, the feature extraction module 122 can extract a facial feature FAC1, a sound feature AUD1 of a commentary made by a commentator in the background, scores A1 and B1 of team A and team B, and a game time C. In certain embodiments, since the scores A1 and B1 may be increased once in a while, or the game time C may decrease as the game progresses, the feature extraction module 122 can analyze and capture such continuity as a series of patterns PTN1 with continuity, and store the series of patterns PTN1 in the buffer storage unit 124 to be used in subsequent comparisons.

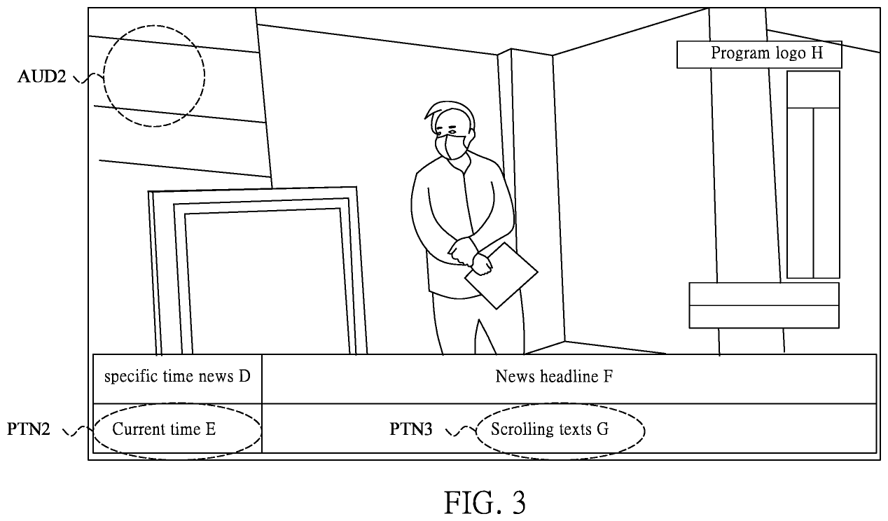

For example, reference can be made to FIG. 3, which is another schematic diagram showing the feature extraction module extracting the channel content according to an embodiment of the present disclosure. For example, FIG. 3 shows a news screen, the feature extraction module 122 can capture an audio feature AUD2 of a reporter reporting in the background, specific time news D (such as a midday news), current time E, and a news headline F, scrolling texts G and a program logo H. In a specific embodiment, since the current time E increases with time, and the scrolling texts G move corresponding texts in a specific direction, the feature extraction module 122 can analyze and extract such continuity as a series of pattern PTN2 and PTN3 with continuities, and the series of pattern PTN2 and PTN3 can be stored in the buffer storage unit 124 to be used in subsequent comparisons.

In an alternative embodiment of the present disclosure, the feature extraction module 122 can also extract a plurality of last program images before the first channel is switched to the second channel as the program image features, for example, the feature extraction module 122 can capture one image per second, and store the captured images in the buffer storage unit 124 to be used in subsequent comparisons.

Next, the comparison module 126 can be configured to, according to the program features stored in the buffer storage unit 124, continuously analyze and compare the channel signal of the first channel to generate a detection result after the first channel is switched to the second channel In detail, the comparison module 126 continuously analyzes the channel signal of the first channel, including analyzing images and sounds, to determine whether or not the channel signal matches to the stored program features.

Next, the reminding module 128 can be configured to determine whether or not to remind a channel switching according to the detection result. In other words, before the user switches the channels, since the program features have been stored, the comparing module 126 can keep analyzing the original channel content in the background after the user switches the channels. When one feature or several features are determined to match the stored program features, the detection result indicates that the advertisement of the channel has ended, and the program has started, the reminder module 128 may determine to make a reminder according to the detection result.

In some embodiments, the reminder module 128 can be configured to, in response to the channel switching being determined to be reminded according to the detection result, remind the channel switching by at least one of sound notification and image notification through the multimedia device 10.

In an alternative embodiment, the reminder module 128 can also be configured to, in response to the channel switching being determined to be reminded according to the detection result, directly control the multimedia device 10 to switch from the second channel to the first channel Therefore, the multimedia channel switching reminding system can be applied to a television. When a user switches channels while a program on a certain channel or an input media viewed by the user enters advertising time, the system and method provided by the present disclosure can continuously monitor the content of the original channel or the input media in background, and remind the user when the advertising time of the original channel or the input media ends, such that the user will not miss preferable programs.

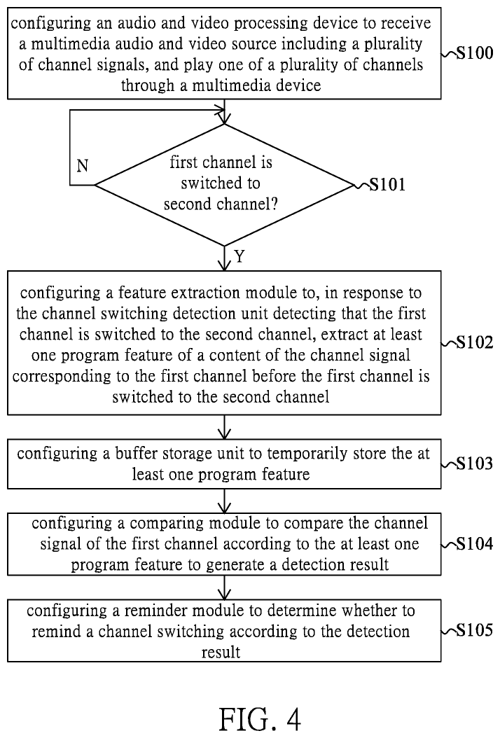

FIG. 4 is a flowchart of a multimedia channel switching reminding method according to an embodiment of the present disclosure. Reference is further made to FIG. 4, the present disclosure further provides a multimedia channel switching reminding method, which can be applied to the multimedia channel switching reminding system of the foregoing embodiment, and the method includes at least the following steps:

Step S100: configuring an audio and video processing device to receive a multimedia audio and video source including a plurality of channel signals, and play one of a plurality of channels through a multimedia device.

Step S101: configuring a channel switching detection unit to detect whether a first channel is switched to a second channel among the plurality of channels. In response to the first channel being detected to be switched to the second channel, the method proceeds to step S102, otherwise the method continuously performs step S101 to perform the detection.

Step S102: configuring a feature extraction module to, in response to the channel switching detection unit detecting that the first channel is switched to the second channel, extract at least one program feature of a content of the channel signal corresponding to the first channel before the first channel is switched to the second channel.

Step S103: configuring a buffer storage unit to temporarily store the at least one program feature.

Step S104: configuring a comparing module to compare the channel signal of the first channel according to the at least one program feature to generate a detection result.

Step S105: configuring a reminder module to determine whether to remind a channel switching according to the detection result.

In conclusion, the multimedia channel switching reminding system and method provided by the present disclosure can be applied to a television. When a user switches channels while a program on a certain channel or an input media viewed by the user plays advertisements, the system and method provided by the present disclosure can continuously monitor the content of the original channel or the input media in background, and remind the user when the advertising time of the original channel or the input media ends, such that the user does not miss out on his preferred programs.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A multimedia channel switching reminding system, comprising:
a multimedia device; and
an audio and video processing device coupled to the multimedia device, receiving a multimedia audio and video source including a plurality of channel signals, and configured to play one of a plurality of channels through the multimedia device, wherein the audio and video processing device includes:
a channel switching detection unit configured to detect whether or not a first channel is switched to a second channel among the plurality of channels;
a feature extraction module configured to, in response to the channel switching detection unit detecting that the first channel is switched to the second channel, extract at least one program feature of a content of the channel signal corresponding to the first channel before the first channel is switched to the second channel;
a buffer storage unit configured to temporarily store the at least one program feature;
a comparing module configured to compare the channel signal of the first channel according to the at least one program feature to generate a detection result; and
a reminder module configured to determine whether or not to provide a reminder for channel switching according to the detection result.

2. The multimedia channel switching reminding system according to claim 1, wherein the at least one program feature includes at least one of program frame features, program mark features, program pattern features, program facial features, and program sound features in the content of the channel signal corresponding to the first channel before the first channel is switched to the second channel

3. The multimedia channel switching reminding system according to claim 2, wherein the program pattern features include a program pattern corresponding to a program type.

4. The multimedia channel switching reminding system according to claim 3, wherein the program pattern is a series of patterns with continuity.

5. The multimedia channel switching reminding system according to claim 1, wherein the reminding module is configured to, in response to the reminder for channel switching being determined to be provided according to the detection result, provide the reminder for channel switching by at least one of sound notification and image notification through the multimedia device.

6. The multimedia channel switching reminding system according to claim 1, wherein the reminder module is configured to, in response to the channel switching being determined to be reminded according to the detection result, directly control the multimedia device to switch from the second channel to the first channel.

7. The multimedia channel switching reminder system according to claim 1, wherein the program frame features include a plurality of program images, and the comparing module is configured to compare the program pictures with the channel signal of the first channel to generate the detection result.

8. A multimedia channel switching reminding method, comprising:
configuring an audio and video processing device to receive a multimedia audio and video source including a plurality of channel signals, and play one of a plurality of channels through a multimedia device;
configuring a channel switching detection unit to detect whether or not a first channel of the channels is switched to a second channel among the plurality of channels;
configuring a feature extraction module to, in response to the channel switching detection unit detecting that the first channel is switched to the second channel, extract at least one program feature of a content of the channel signal corresponding to the first channel before the first channel is switched to the second channel;
configuring a buffer storage unit to temporarily store the at least one program feature;
configuring a comparing module to compare the channel signal of the first channel according to the at least one program feature to generate a detection result; and
configuring a reminder module to determine whether or not to remind a channel switching according to the detection result.

9. The multimedia channel switching reminding method according to claim 8, wherein the at least one program feature includes at least one of program frame features, program mark features, program pattern features, program facial features, and program sound features in the content of the channel signal corresponding to the first channel before the first channel is switched to the second channel

10. The multimedia channel switching reminding method according to claim 9, wherein the program pattern features include a program pattern corresponding to a program type.

11. The multimedia channel switching reminding method according to claim 10, wherein the program pattern is a series of patterns with continuity.

12. The multimedia channel switching reminding method according to claim 8, further comprising:
configuring the reminding module to, in response to the channel switching being determined to be reminded according to the detection result, remind the channel switching by at least one of sound notification and image notification through the multimedia device.

13. The multimedia channel switching reminding method according to claim 8, further comprising:
configuring the reminder module to, in response to the channel switching being determined to be reminded according to the detection result, directly control the multimedia device to switch from the second channel to the first channel.

14. The multimedia channel switching reminding method according to claim 8, wherein the program frame features include a plurality of program pictures, and the multimedia channel switching reminding method further comprises configuring the comparing module to compare the program pictures with the channel signal of the first channel to generate the detection result.
